(19) United States
(12) Patent Application Publication
(10) Pub. No.: US 2021/0367954 A1
(43) Pub. Date: Nov. 25, 2021

(54) SYSTEM AND METHOD FOR TRANSACTION AUTHENTICATION

(71) Applicant: Avaya Management L.P., Santa Clara, CA (US)

(72) Inventors: Navin Daga, Silapathar (IN); Sandesh Chopdekar, Kondhwa (IN); Pushkar Yashavant Deole, Karvenagar (IN)

(21) Appl. No.: 16/879,049

(22) Filed: May 20, 2020

(51) Int. Cl. H04L 29/06

(52) U.S. Cl. CPC H04L 63/1416; H04L 63/0838

(57) ABSTRACT

Embodiments of the disclosure provide a method, system, and server for authenticating transactions. In an example, the server includes instructions that process a transaction initiation message received from a first communication device, instructions that transmit a security message to a trusted communication device in response to processing the transaction initiation message, where the security message comprises a time-sensitive code, instructions that receive and process a response message to the security message, where the response message includes a location identifier that describes a location of the trusted communication device and/or call history of the trusted communication device, which may be configured to include call content extracted from a call monitored at the trusted communication device. Some or all of the information in the response message can be used for purposes of identifying a possibly fraudulent transaction.

### FIELD

Embodiments of the present disclosure relate generally to communication methods and specifically to communication methods used to authenticate transactions.

### BACKGROUND

Voice phishing (vishing) and social engineering techniques have been around for some time, but the approaches taken by attackers continue to develop. People continue to fall prey to old and new techniques and, as a result, reveal sensitive information to attackers. Even with security measures like One Time Passwords (OTPs) in place, unsuspecting victims still share the OTP with an attacker, thereby enabling the attacker to carry out a fraudulent transaction or gain access to the victim's sensitive information.

### BRIEF SUMMARY

Embodiments of the present disclosure aim to solve these and other problems associated with authenticating transactions. Embodiments of the present disclosure are particularly well suited to thwart vishing attacks and other related social engineering attacks, but it should be appreciated that the claims are not so limited.

In some embodiments, a system and method are proposed to gather location information from a trusted communication device and correlate that location information with a location from which a transaction is being initiated. Based on the results of the location comparison, it may be possible to automatically identify a valid transaction or a possibly fraudulent transaction. In the event that a possibly fraudulent transaction is identified, embodiments of the present disclosure contemplate a number of responsive measures. For instance, the user of the trusted communication device may be alerted as to the possibly fraudulent transaction, security personnel may be alerted as to the possibly fraudulent transaction, the transaction may be blocked or delayed until such time as additional security steps are taken, etc. Conversely, if the transaction is identified as a valid transaction, then the system and method may allow the transaction to continue automatically and without requiring further user input.

In some embodiments, a sequence of events may occur like the following:

The proposed solution works by gathering the location of the device and correlating that to the place of transaction to alert the user and/or block the transaction in the following way: (1) user receives a vishing call where the attacker sounds like a genuine person calling on behalf of some services that the customer uses; (2) attacker tricks the user to reveal sensitive information like card details, security question, etc.; (3) using the information gathered, the attacker initiates a transaction; (4) user then receives a security message from their transaction processor, the security message may include OTP/secure code as a second level of authentication to complete the transaction; (5) the legitimate application of the corresponding service provider on the user's trusted communication device reads the security message and on identifying the security message and request for information therein, the trusted application on the communication device sends the device's location and call history to the transaction processor, where it is processed by a transaction server; (6) the transaction server then checks the usage of the OTP/secure code and based on the device's location and its usage, the transaction server detects the possibility of a fraudulent transaction; (7) in response to detecting the possibility of a fraudulent transaction, the transaction server may send the data back to the application on the trusted communication device, which can then alert the user through a notification about a possible fraudulent transaction and option to block it; (8) if the transaction server is confident of the fraud detection, the transaction server can also add another layer of authentication/security before authorizing this transaction which gives the user time to react.

It should be appreciated that a possibly fraudulent transaction can be detected in a number of different ways. As noted above, the transaction server can use the trusted communication device's location, origin of transaction, and/or call history to determine possibility of a fraud.

Generally speaking, the trusted communication device's location and transaction origin would match or at least be substantially close to one another (e.g., in a same building, etc.). Any deviation between location of the trusted communication device and transaction origin can trigger an alert. It can also be possible that the user has genuinely shared the secure code with someone. In that case, it will lead to a false alert but the system can learn by keeping records of possible locations of transactions other than the current trusted communications device's location, which should not be too large.

In situations where a possibly fraudulent transaction is detected, the system can also analyze call history information received from the trusted communication device to determine if an authorized call regarding their services has been made to the user or not. The system can use this data to further determine whether to alert the user.

In some embodiments, the trusted communication device may be provided with an application that is configured to monitor inbound and outbound calls at the trusted communication device. In particular, the application may monitor the content of calls with a number from one of the trusted services being provided to the user. As part of monitoring the content of the calls, the application may transcribe the content of the call and determine if any unwanted or sensitive information has been requested by the service provider. If a request for unwanted or sensitive information has been detected, then the application may flash a message to the user indicating to the user that they should not respond to the request.

In this way, even if the attacker manages to spoof the caller ID of the service provider, the application, based on content of the call, can identify an attack and warn the user appropriately. The application may further alert the user or even automatically terminate the call and alert the service provider about the spoofed call and possible attack. In some embodiments, the application can be configured to alert the user accordingly, to not share the information with anyone. The application may also be configured to ask the user whether the user is initiating the transaction or someone else is initiating the transaction. Based on the series of questions, the application can determine if the transaction is legitimate or not.

It is another aspect of the present disclosure to enable an application on the user's trusted communication device to monitor the user's activity and determine a security awareness quotient for the user. If the quotient is determined to be low for the user (e.g., below a predetermined threshold value), then additional security measures can be put into place for transactions associated with that user. For instance, if the user's security awareness quotient is low, the application may be configured to give a warning to a user when any transaction is initiated by a device other than the user's trusted communication device.

It is another aspect of the present disclosure to enable a system and method to use the location and call history information to identify other possibly fraudulent transactions. For instance, the system may be configured to learn about call history or location information that is associated with a fraudulent transaction and correlate that information to future transactions. If a future transaction includes any location or call history information that matches or nearly matches location or call history information associated with a previously-identified fraudulent transaction, then the system may automatically identify the new transaction as possibly fraudulent or at least implement additional security requirements for the transaction to proceed.

In some embodiments, a method of authenticating a transaction at a transaction server is provided that includes:

receiving, at a processor and from a first communication device, a transaction initiation message;

determining, with the processor, an address of a trusted communication device to validate the transaction initiation message;

transmitting, with the processor, a security message to the trusted communication device, wherein the security message comprises a time-sensitive code;

receiving, with the processor and from the trusted communication device, a response message to the security message, wherein the response message comprises a location identifier that describes a location of the trusted communication device;

comparing, with the processor, the location of the trusted communication device as described by the location identifier in the response message with a location of the first communication device;

determining, with the processor, that the user entered the time-sensitive code at the trusted communication device within the predetermined amount of time;

identifying the transaction initiation message as either valid or possibly fraudulent in response to: (1) comparing the location of the trusted communication device as described by the location identifier in the response message with the location of the first communication device and (2) determining that the user entered the time-sensitive code within the predetermined amount of time; and

performing, with the processor, one of the following:
(i) automatically allowing the transaction to occur based on the transaction initiation message being identified as valid; and
(ii) transmitting a fraudulent transaction alert based on the transaction initiation message being identified as possibly fraudulent.

In some embodiments, a communication system for authenticating a transaction is provided that includes:

a processor; and

computer memory storing data thereon that enables the processor to:
receive, from a first communication device, a transaction initiation message;
determine an address of a trusted communication device to validate the transaction initiation message;
transmit a security message to the trusted communication device, wherein the security message comprises a time-sensitive code;
receive, from the trusted communication device, a response message to the security message, wherein the response message comprises a location identifier that describes a location of the trusted communication device;
compare the location of the trusted communication device as described by the location identifier in the response message with a location of the first communication device;
determine whether or not the user entered the time-sensitive code within the predetermined amount of time;
identify the transaction initiation message as either valid or possibly fraudulent in response to: (1) comparing the location of the trusted communication device as described by the location identifier in the response message with the location of the first communication device and (2) determining whether or not the user entered the time-sensitive code within the predetermined amount of time; and
perform one of the following:
   (i) automatically allow the transaction to occur based on the transaction initiation message being identified as valid; and
   (ii) transmit a fraudulent transaction alert based on the transaction initiation message being identified as possibly fraudulent.

In some embodiments, a transaction server is provided that includes:

a processor; and

memory storing instructions there that are executable by the processor, wherein the instructions comprise:
instructions that process a transaction initiation message received from a first communication device;
instructions that transmit a security message to a trusted communication device in response to processing the transaction initiation message, wherein the security message comprises a time-sensitive code;
instructions that receive and process a response message to the security message, wherein the response message comprises a location identifier that describes a location of the trusted communication device;
instructions that compare the location of the trusted communication device as described by the location identifier in the response message with a location of the first communication device;
instructions that determine whether or not the user entered the time-sensitive code within the predetermined amount of time;
instructions that identify the transaction initiation message as possibly fraudulent in response to at least one of: (1) comparing the location of the trusted communication device as described by the location identifier in the response message with the location of the first communication device and (2) determining whether the user entered the time-sensitive code within the predetermined amount of time; and
instructions that transmit a fraudulent transaction alert based on the transaction initiation message being identified as possibly fraudulent.

Although aspects of the present disclosure will be described with respect to a visher, it should be appreciated that the term “visher”, as used herein, may refer to any person or entity that is attempting to attack, steal, or otherwise improperly benefit from information obtained from another person. A visher may utilize voice communication channels to obtain such information, but other channels (e.g., non-voice channels) may also be used in addition to or in lieu of a voice channel. Thus, the use “visher” should not be construed to limit embodiments of the present disclosure to attackers using a voice communication channel.

As used herein, the phrases “at least one,” “one or more,” “or,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C,” “A, B, and/or C,” and “A, B, or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “comprising,” “including,” and “having” can be used interchangeably.

The term “automatic” and variations thereof, as used herein, refers to any process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

The term “computer-readable medium” as used herein refers to any tangible storage and/or transmission medium that participate in providing instructions to a processor for execution. Such a medium may take many forms, including but not limited to, non-volatile media, volatile media, and transmission media. Non-volatile media includes, for example, NVRAM, or magnetic or optical disks. Volatile media includes dynamic memory, such as main memory. Common forms of computer-readable media include, for example, a floppy disk, a flexible disk, hard disk, magnetic tape, or any other magnetic medium, magneto-optical medium, a CD-ROM, any other optical medium, punch cards, paper tape, any other physical medium with patterns of holes, a RAM, a PROM, and EPROM, a FLASH-EPROM, a solid state medium like a memory card, any other memory chip or cartridge, a carrier wave as described hereinafter, or any other medium from which a computer can read. A digital file attachment to e-mail or other self-contained information archive or set of archives is considered a distribution medium equivalent to a tangible storage medium. When the computer-readable media is configured as a database, it is to be understood that the database may be any type of database, such as relational, hierarchical, object-oriented, and/or the like. Accordingly, the disclosure is considered to include a tangible storage medium or distribution medium and prior art-recognized equivalents and successor media, in which the software implementations of the present disclosure are stored.

A “computer readable signal” medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable medium may be transmitted using any appropriate medium, including but not limited to wireless, wireline, optical fiber cable, RF, etc., or any suitable combination of the foregoing.

The terms “determine,” “calculate,” and “compute,” and variations thereof, as used herein, are used interchangeably and include any type of methodology, process, mathematical operation, or technique.

It shall be understood that the term “means” as used herein shall be given its broadest possible interpretation in accordance with 35 U.S.C., Section 112, Paragraph 6. Accordingly, a claim incorporating the term “means” shall cover all structures, materials, or acts set forth herein, and all of the equivalents thereof. Further, the structures, materials or acts and the equivalents thereof shall include all those described in the summary of the disclosure, brief description of the drawings, detailed description, abstract, and claims themselves.

Aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Any combination of one or more computer readable medium(s) may be utilized. The computer readable medium may be a computer readable signal medium or a computer readable storage medium.

In yet another embodiment, the systems and methods of this disclosure can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this disclosure. Exemplary hardware that can be used for the disclosed embodiments, configurations, and aspects includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

Examples of the processors as described herein may include, but are not limited to, at least one of Qualcomm® Snapdragon® 800 and 801, Qualcomm® Snapdragon® 610 and 615 with 4G LTE Integration and 64-bit computing, Apple® A7 processor with 64-bit architecture, Apple® M7 motion coprocessors, Samsung® Exynos® series, the Intel® Core™ family of processors, the Intel® Xeon® family of processors, the Intel® Atom™ family of processors, the Intel Itanium® family of processors, Intel® Core® i5-4670K and i7-4770K 22 nm Haswell, Intel® Core® i5-3570K 22 nm Ivy Bridge, the AMD® FX™ family of processors, AMD® FX-4300, FX-6300, and FX-8350 32 nm Vishera, AMD® Kaveri processors, Texas Instruments® Jacinto C6000™ automotive infotainment processors, Texas Instruments® OMAP™ automotive-grade mobile processors, ARM® Cortex™-M processors, ARM® Cortex-A and ARM926EJ-S™ processors, other industry-equivalent processors, and may perform computational functions using any known or future-developed standard, instruction set, libraries, and/or architecture.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this disclosure is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this disclosure can be implemented as program embedded on personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Methods described or claimed herein can be performed with traditional executable instruction sets that are finite and operate on a fixed set of inputs to provide one or more defined outputs. Alternatively or additionally, methods described or claimed herein can be performed using AI, machine learning, neural networks, or the like. In other words, a system or contact center is contemplated to include finite instruction sets and/or artificial intelligence-based models/neural networks to perform some or all of the steps described herein.

### BRIEF DESCRIPTION OF THE DRAWINGS

FIG. 1 is a block diagram illustrating a communication system in accordance with at least some embodiments of the present disclosure;

FIG. 2 is a block diagram depicting message exchanges during a valid transaction in accordance with at least some embodiments of the present disclosure;

FIG. 3 is a block diagram depicting message exchanges during a possibly fraudulent transaction in accordance with at least some embodiments of the present disclosure;

FIG. 4 is a flow diagram depicting a method of authenticating a transaction in accordance with at least some embodiments of the present disclosure;

FIG. 5 is a flow diagram depicting a method of operating a user's communication device to identify a possibly fraudulent transaction in accordance with at least some embodiments of the present disclosure; and

FIG. 6 is a flow diagram depicting a method of determining a user's security awareness quotient and acting appropriately in accordance with at least some embodiments of the present disclosure.

### DETAILED DESCRIPTION

In the following description, for the purposes of explanation, numerous specific details are set forth in order to provide a thorough understanding of various embodiments disclosed herein. It will be apparent, however, to one skilled in the art that various embodiments of the present disclosure may be practiced without some of these specific details. The ensuing description provides exemplary embodiments only, and is not intended to limit the scope or applicability of the disclosure. Furthermore, to avoid unnecessarily obscuring the present disclosure, the preceding description omits a number of known structures and devices. This omission is not to be construed as a limitation of the scopes of the claims. Rather, the ensuing description of the exemplary embodiments will provide those skilled in the art with an enabling description for implementing an exemplary embodiment. It should however be appreciated that the present disclosure may be practiced in a variety of ways beyond the specific detail set forth herein.

While the exemplary aspects, embodiments, and/or configurations illustrated herein show the various components of the system collocated, certain components of the system can be located remotely, at distant portions of a distributed network, such as a Local Area Network (LAN) and/or the Internet, or within a dedicated system. Thus, it should be appreciated, that the components of the system can be combined in to one or more devices or collocated on a particular node of a distributed network, such as an analog and/or digital telecommunications network, a packet-switched network, or a circuit-switched network. It will be appreciated from the following description, and for reasons of computational efficiency, that the components of the system can be arranged at any location within a distributed network of components without affecting the operation of the system.

Embodiments of the disclosure provide systems and methods for authenticating transactions initiated by a communication device by engaging a trusted communication device. Embodiments contemplate the use of location information and/or call history information from the trusted communication device as part of authenticating such transactions.

Various additional details of embodiments of the present disclosure will be described below with reference to the figures. While the flowcharts will be discussed and illustrated in relation to a particular sequence of events, it should be appreciated that changes, additions, and omissions to this sequence can occur without materially affecting the operation of the disclosed embodiments, configuration, and aspects.

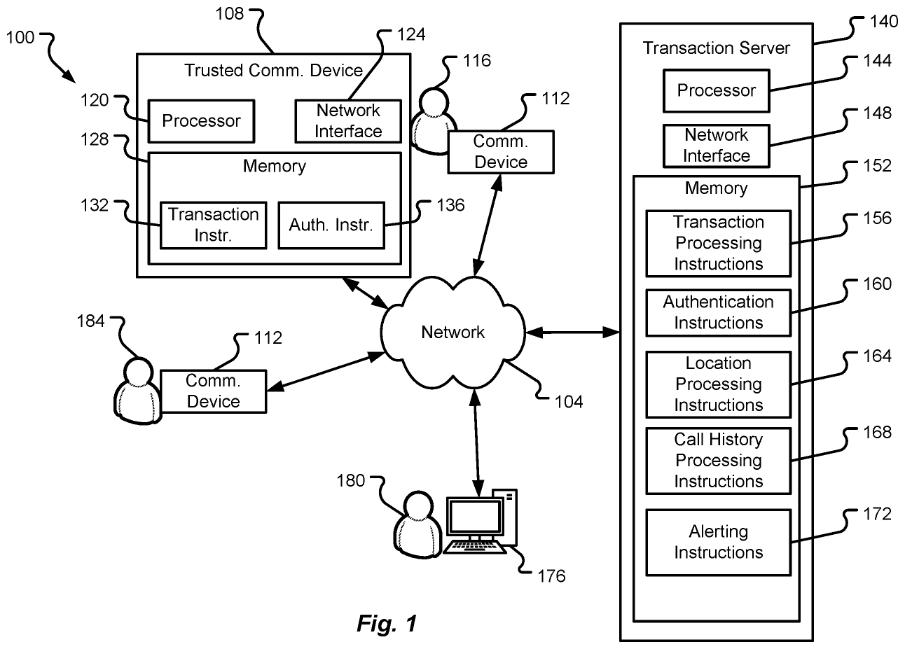

Referring initially to FIG. 1, a communication system 100 will be described in accordance with at least some embodiments of the present disclosure. The communication system 100 is shown to include a communication network 104 that interconnects a transaction server 140 with a number of communication devices 112, trusted communication devices 108, and administrative communication devices 176. A user 116 may have access to both a communication device 112 and a trusted communication device 108. The user 116 may correspond to a subscribing user of a service provided by the transaction server 140 or an entity that operates the transaction server 140. In some embodiments, the user 116 may correspond to a customer of a service provider that enables the user 116 to initiate and execute transactions (e.g., financial transactions, business transactions, electronic transactions, etc.). The transaction server 140 may be provided with components that enable transaction requests to be analyzed and authenticated. Specifically, the transaction server 140 may be configured to implement authentication processes that distinguish valid transactions (e.g., a transaction initiated by a true user 116) from invalid or possibly fraudulent transactions (e.g., a transaction initiated by an attacker 184). Because the attacker 184 also has access to a communication device 112, the transaction server 140 is provided to analyze transaction initiation messages received from any communication device 112 (e.g., those received from a communication device 112 or trusted communication device 108 or a user 116 as well as those received from a communication device 112 of an attacker 184).

The attacker 184 may correspond to a person or entity that attempts to fraudulently conduct a transaction with information obtained from user 116. In some embodiments, the attacker 184 may utilize vishing or other social engineering attacks to obtain certain amounts of secure or sensitive information directly from the user 116. The attacker 184 may then utilize the information obtained from the user 116 to try and execute a transaction with valid transaction data, but in such a way that the attacker 184 receives the benefit of the transaction instead of the user 116 receiving the benefit of the transaction. It should be appreciated that a fraudulent transaction executed by the transaction server 140 for the benefit of the attacker 184 may damage the user 116 and/or the legitimate entity registered with the service provider. Accordingly, the transaction server 140 is provided with components that enable authentication processes to be performed when a transaction initiation message is received from a communication device 112. Additional details of such authentication processes will be described in further detail herein.

The trusted communication device 108 and communication device 112 may be owned and/or operated by a user 116. As shown in FIG. 1, a user 116 may utilize one or multiple customer communication devices 108, 112 to interact with their transaction service provider. Moreover, embodiments of the present disclosure contemplate that the user 116 may use a communication device 112 to initiate a transaction and then the transaction server 140 may leverage the trusted communication device 108 to authenticate the transaction. Alternatively, or additionally, the user 116 may be allowed to initiate a transaction with their trusted communication device 108 and the transaction server 140 leverages the trusted communication device 108 to authenticate the transaction. At least some of the authentication processes described herein assume that the trusted communication device 108 is within the possession or control of user 116; however, it should be appreciated that various authentication processes do not necessarily require the trusted communication device 108 to be within the possession of the user 116 so long as the trusted communication device 108 is not compromised or control of the trusted communication device 108 has not been lost by the user 116.

A trusted communication device 108 or communication device 112 may correspond to a computing device, a personal communication device, a portable communication device, a laptop, a smartphone, a personal computer, and/or any other device capable of running an operating system, a web browser, or the like. For instance, a communication device 108, 112 may be configured to operate various versions of Microsoft Corp.'s Windows® and/or Apple Corp.'s Macintosh® operating systems, any of a variety of commercially-available UNIX® such as LINUX or other UNIX-like operating systems, iOS, Android®, etc. These communication devices 108, 112 may also have any of a variety of applications, including for example, a database client and/or server applications, web browser applications, chat applications, social media applications, calling applications, etc. A communication device 108, 112 may alternatively or additionally be any other electronic device, such as a thin-client computer, Internet-enabled mobile telephone, and/or personal digital assistant, capable of communicating via communication network 104 and/or displaying and navigating web pages or other types of electronic documents.

Components of a trusted communication device 108 are depicted, but it should be appreciated that a communication device 112 may have similar components. Illustratively, the trusted communication device 108 includes a processor 120, a network interface 124, and memory 128. Similar components may be provided in a communication device 112. What differentiates the communication device 112 from a trusted communication device 108 is that the trusted communication device 108 has been provisioned or registered to work in concert with the transaction server 140 to support authentication processes. The trusted communication device 108 may also be provided with optional capabilities that enable the trusted communication device 108 to perform security processes directly at the trusted communication device 108 (e.g., without support from the transaction server 140). In other words, the trusted communication device 108 may be configured to support authentication processes performed by the transaction server 140 in addition to performing authentication processes locally.

The processor 120 may correspond to any type of processing device or collection of processing devices. Illustratively, the processor 120 may include a microprocessor, an Integrated Circuit (IC) chip, a General Processing Unit (GPU), a Central Processing Unit (CPU), combinations thereof, or the like.

The network interface 124 may include any device or collection of devices that enable the trusted communication device 108 to connect with the network 104 and exchange messages, packets, or communications with other communication devices 112 and/or the transaction server 140. In some embodiments, the network interface 124 may facilitate wired and/or wireless connectivity with the network 104. As an example, the network interface 124 may include a Network Interface Card (NIC), serial communication ports, parallel communication ports, encoders, decoders, amplifiers, modulators, demodulators, antennas, filters, etc.

The memory 128 may correspond to one or many memory devices that are configured to electronically store information, data, program instructions, and the like. As a non-limiting example, the memory 128 may be volatile and/or non-volatile in nature. Specific types of memory devices that may be provided as memory 128 include, without limitation, Random Access Memory (RAM) devices, Read Only Memory (ROM) devices, flash memory devices, magnetic disk storage media, optical storage media, solid-state storage devices, core memory, buffer memory devices, combinations thereof, and the like.

As mentioned above, the trusted communication device 108 may be configured to support operations of the transaction server 140 as well as perform security processes locally and without the transaction server 140. The memory 128 is shown to include transaction instructions 132 and authentication instructions 136. The transaction instructions 132 may correspond to the instructions stored in the trusted communication device 108 that interact with the transaction server 140 whereas the authentication instructions 136 may correspond to the instructions stored in the trusted communication device 108 that perform security processes locally. The transaction instructions 132 and authentication instructions 136 may be provided within a single application that is also stored in memory 128. In some embodiments, the single application may be provided by a service provider that also controls and operates the transaction server 140. Accordingly, the single application may be considered a trusted application that operates on the trusted communication device 108 to support transactions provided by the service provider. As will be discussed in further detail herein, the transaction instructions 132 may be configured to monitor a location of the trusted communication device 108 using any type of locating technology (e.g., GPS, WiFi, Bluetooth®, etc.). The transaction instructions 132 may also be configured to monitor a communication history (e.g., call logs, email accounts, chat accounts, social media accounts, etc.) and the content of messages exchanged during communications between the trusted communication device 108 and another device. The transaction instructions 132 may be configured to receive a security message from the transaction server 140 and respond to the security message by presenting appropriate information to the user 116 via a user interface of the trusted communication device 108 and by further sharing location and/or call history information associated with the trusted communication device 108 to the transaction server 140. The location and/or call history information provided to the transaction server 140 by the trusted communication device 108 may enable the transaction server 140 to authenticate transactions initiated by the user 116 and automatically allow such transactions to continue as long as other authentication conditions are met (e.g., an OTP has been properly entered by the user 116). Alternatively, the location and/or call history information provided to the transaction server 140 may enable the transaction server 140 to identify possibly fraudulent transactions (e.g., transactions initiated by an attacker 184) as will be described in further detail herein.

The authentication instructions 136 may correspond to the instructions of the trusted communication device 108 that perform local security processes. For instance, the authentication instructions 136 may be configured to monitor communications between the trusted communication device 108 and other communication device 112 to determine if sensitive or personal information is being shared or requested by an attacker 184. The authentication instructions 136 may also be configured to alert the user 116 when possibly security risks are occurring. In some embodiments, the authentication instructions 136 may be configured to monitor a behavior of the user 116 and interactions between the user 116 and the trusted communication device 108 for purposes of determining a security awareness quotient for the user 116. The authentication instructions 136 may then be configured to implement certain security processes or additional security processes. As such, the authentication instructions 136 may also be configured to share the security awareness quotient with the transaction instructions 132 for purposes of enabling the transaction server 140 to increase or decrease security processes associated with transactions for the user 116.

The communication network 104 can be any type of network familiar to those skilled in the art that can support data communications using any of a variety of commercially-available protocols, including without limitation SIP, TCP/IP, SNA, IPX, AppleTalk, and the like. Merely by way of example, the communication network 104 may correspond to a LAN, such as an Ethernet network, a Token-Ring network and/or the like; a wide-area network; a virtual network, including without limitation a virtual private network (“VPN”); the Internet; an intranet; an extranet; a public switched telephone network (“PSTN”); an infra-red network; a wireless network (e.g., a network operating under any of the IEEE 802.9 suite of protocols, the IEEE 802.11 suite of protocols, the Bluetooth® protocol known in the art, and/or any other wireless protocol); and/or any combination of these and/or other networks.

The transaction server 140 may be configured to support any number of communication protocols or applications. The transaction server 140 may include any number of components to support transaction execution and authentication. Non-limiting examples of communication protocols or applications that may be used by the transaction server 140 to facilitate transactions include the Session Initiation Protocol (SIP), File Transfer Protocol (FTP), Hypertext Transfer Protocol (HTTP), HTTP secure (HTTPS), Transmission Control Protocol (TCP), Java, Hypertext Markup Language (HTML), Short Message Service (SMS), Internet Relay Chat (IRC), Web Application Messaging (WAMP), SOAP, MIME, Real-Time Messaging Protocol (RTP), Web Real-Time Communications (WebRTC), WebGL, XMPP, Skype protocol, AIM, Microsoft Notification Protocol, email, etc. In addition to supporting digital transactions, the transaction server 140 may also be configured to support non-text-based communications such as voice communications, video communications, and the like, whether for purposes of executing transactions or not.

While certain components are depicted as being included in the transaction server 140, it should be appreciated that such components may be provided in any other server or set of servers without departing from the scope of the present disclosure.

The transaction server 140 is shown to include a processor 144, a network interface 148, and memory 152. The processor 144 may be similar to processor 120 and may correspond to one or many computer processing devices. Non-limiting examples of a processor 144 include a microprocessor, an Integrated Circuit (IC) chip, a General Processing Unit (GPU), a Central Processing Unit (CPU), or the like. Examples of the processor 144 as described herein may include, but are not limited to, at least one of Qualcomm® Snapdragon® 800 and 801, Qualcomm® Snapdragon® 620 and 615 with 4G LTE Integration and 64-bit computing, Apple® A7 processor with 64-bit architecture, Apple® M7 motion coprocessors, Samsung® Exynos® series, the Intel® Core™ family of processors, the Intel® Xeon® family of processors, the Intel® Atom™ family of processors, the Intel Itanium® family of processors, Intel® Core® i5-4670K and i7-4770K 22 nm Haswell, Intel® Core® i5-3570K 22 nm Ivy Bridge, the AMD® FX™ family of processors, AMD® FX-4300, FX-6300, and FX-8350 32 nm Vishera, AMD® Kaveri processors, Texas Instruments® Jacinto C6000™ automotive infotainment processors, Texas Instruments® OMAP™ automotive-grade mobile processors, ARM® Cortex™-M processors, ARM® Cortex-A and ARIV1926EJ-S™ processors, other industry-equivalent processors, and may perform computational functions using any known or future-developed standard, instruction set, libraries, and/or architecture.

The network interface 148 may be similar to network interface 124 and may be configured to enable the transaction server 140 to communicate with other machines connected with the communication network 104. The network interface 148 may include, without limitation, a modem, a network card (wireless or wired), an infra-red communication device, etc.

The memory 152 may be similar to memory 128 and may include one or multiple computer memory devices. The memory 152 may be configured to store program instructions that are executable by the processor 144 and that ultimately provide functionality of the transaction server 140 described herein. The memory 152 may also be configured to store data or information that is useable or capable of being called by the instructions stored in memory 152. The memory 152 may include, for example, RAM devices, ROM devices, flash memory devices, magnetic disk storage media, optical storage media, solid-state storage devices, core memory, buffer memory devices, combinations thereof, and the like. The memory 152, in some embodiments, corresponds to a computer-readable storage media and while the memory 152 is depicted as being internal to the transaction server 140, it should be appreciated that the memory 152 may correspond to a memory device, database, or appliance that is external to the transaction server 140.

Illustratively, the memory 152 is shown to store transaction processing instructions 156, authentication instructions 160, location processing instructions 164, call history processing instructions 168, and alerting instructions 172. In some embodiments, the instructions 156,160, 164, 168, 172 may correspond to processor-executable instructions (e.g., a finite instruction set with defined inputs, variables, and outputs). In some embodiments, one or more of the instructions depicted as being included in memory 152 may correspond to an Artificial Intelligence (AI) component of the transaction server 140 that is executed by the processor 144.

The transaction processing instructions 156, when executed by the processor 144, may enable the transaction server 140 to receive transaction initiation messages, transmit security messages, and perform other message exchanges in connection with facilitating execution of a transaction. The transaction processing instructions 156 may call the authentication instructions 160 for purposes of authenticating a transaction, determining if the transaction is a valid transaction, and/or identifying possibly fraudulent transactions. In some embodiments, the authentication instructions 160, when executed by the processor 144, may enable the transaction server 140 to analyze conditions surrounding a transaction to determine if the transaction is valid or possibly fraudulent.

For instance, the authentication instructions 160 may be configured to call the location processing instructions 164 and call history processing instructions 168 for purposes of analyzing location information and call history information received from a trusted communication device 108 in a response to a security message. The location processing instructions 164 may be configured to analyze location information received from the trusted communication device 108 that describes a location or approximate location (e.g., whose accuracy is limited based on the location protocol being employed) of the trusted communication device 108. Location information received from the trusted communication device 108 may be compared with location information associated with a communication device 112 that transmitted a transaction initiation message to the transaction server 140. If the location information for the trusted communication device 108 is not substantially the same as the location information associated with the communication device 112 that transmitted the transaction initiation message, then the location processing instructions 164 may notify the authentication instructions 160 and additional security steps may be performed or the alerting instructions 172 may be automatically invoked to transmit an alert message to the trusted communication device 108 and/or a communication device 176 of security personnel 180 that is monitoring transactions facilitated by the transaction server 140. It should be appreciated that the alerting instructions 172 may be configured to simultaneously alert both the user 116 and security personnel 180.

The call history processing instructions 168, when executed by the processor 144, may enable the transaction server 140 to analyze call history information received from the trusted communication device 108 and determine if any entries in the call history information match a number used by the communication device 112 that transmitted the transaction initiation message. If there is a match, then the call history processing instructions 168 may determine that the transaction is a possibly fraudulent transaction. On the other hand, the number of the communication device 112 may be presented in the call history of the trusted communication device 108, but with a significant amount of frequency (e.g., more than one call per week), which suggests that there is a valid connection between the trusted communication device 108 and communication device 112. This valid connection may suggest that a transaction initiated by the communication device 112 is possibly valid (as opposed to invalid), which may suggest either allowing the transaction to occur or taking some minor steps in connection with allowing the transaction to occur. In some embodiments, the call history processing instructions 168 may be configured to determine if the number associated with the entity that transmitted the transaction initiation message is within a list of contacts (e.g., trusted numbers) for the trusted communication device 108. If this is the case and the number of the communication device 112 that transmitted the transaction initiation message is a reliable contact (or favorite contact) in the address book of the trusted communication device 108, then it may not be unexpected to receive a transaction initiation message from the communication device 112. Thus, a number's presence in the call history information received from the trusted communication device 108 may be informative of a possibly valid transaction depending upon the circumstances and other context that can be determined by the transaction server 140. If, however, the call history indicates a single/isolated communication instance between the communication device 112 that transmitted the transaction initiation message and the trusted communication device 108, then a transaction may be identified as possibly fraudulent—although such a conclusion is not always required. In some cases, the attacker 184 may also spoof their caller id to appear the same (or similar) as a call initiated by service provider like bank. Accordingly, the call history processing instructions 168 can also analyze the conversation in the call to see if anything illegitimate is being asked by the caller like sharing of secure code, OTP, credit card details or security question, which would prompt the transaction to be identified as possibly fraudulent and the user 116 may be notified appropriately. Further still, if a call is ongoing when the security code is received by the user 116 then that call could be monitored for terms like share the OTP, secure code etc. and that information will also be used to determine possibly fraud.

Output of the call history processing instructions 168 may be provided to the authentication instructions 160 in a similar way that outputs of the location processing instructions 164 are provided to the authentication instructions 160. Based on outputs received from the location processing instructions 164 and call history processing instructions 168, the authentication instructions 160 may determine whether a particular transaction initiation message is associated with a valid transaction or a possibly fraudulent transaction.

While the call history processing instructions 168 are described as being configured to analyze call history information in the form of incoming/outgoing voice calls, it should be appreciated that call history information may include information describing other types of communications conducted by the trusted communication device 108. For instance, the call history information may include information from text communications, email communications, chats, social media messages, etc.

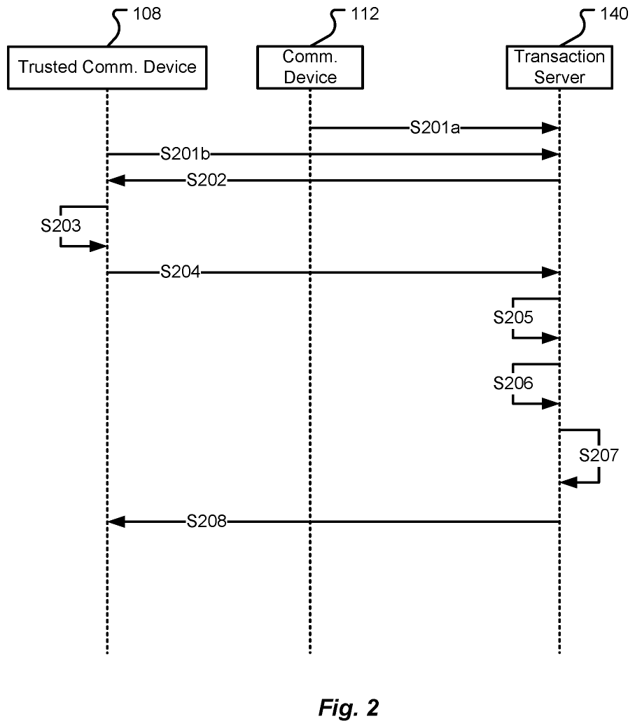

With reference now to FIG. 2, an illustrative message exchange for a valid (or possibly valid) transaction will be described in accordance with at least some embodiments of the present disclosure. While described as a possibly valid transaction, it should be appreciated that some or all of the message exchanges described in connection with FIG. 2 may be determined to belong to a possibly invalid or fraudulent transaction that is initiated by an attacker 184 rather than a legitimate user 116.

The message exchange may include a communication device 112 or trusted communication device 108 transmitting a transaction initiation message (S201a or S201b, respectively) to the transaction server 140.

The transaction server 140 may invoke the transaction processing instructions 156 in response to receiving the transaction initiation message (S201a or S201b). The transaction processing instructions 156 may then call the authentication instructions 160, which cause the transaction server to determine an address of the trusted communication device 108 and transmit a security message (S202) to the trusted communication device 108.

The trusted communication device 108 may receive the security message (S202) and process the information contained in the security message (S202). In particular, the trusted communication device 108 may utilize its transaction instructions 132 and extract a time-sensitive code from the security message (S202). The time-sensitive code may be presented to the user 116 of the trusted communication device 108 such that the user 116 has to re-enter (S203) the time-sensitive code via a user interface of the trusted communication device 108 (or some other transacting device like communication device 112) within a predetermined amount of time of receiving the security message (S202). If the user 116 re-enters (S203) the time-sensitive code at the trusted communication device 108 (or some other transacting device) within the predetermined amount of time, then the trusted communication device 108 may transmit a response message (S204) back to the transaction server 140. In some embodiments, the response message (S204) need not wait for the time-sensitive code to be entered. Rather, the response message (S204) could be triggered in response to the trusted application on the trusted communication device 108 recognizing that a security message (S202) has been received and contains a time-sensitive code. This response message (S204) may be generated and formatted by the transaction instructions 132. In some embodiments, the response message (S204) may be generated to include location information and/or call history information for the trusted communication device 108. More specifically, the response message (S204) may include a location identifier that describes a location of the trusted communication device 108 at a time that the user 116 entered the time-sensitive code. The location identifier may be provided as GPS coordinates, network access point location, network access point identifier, network name, city name, street name, state name, country name, building information, etc. The response message (S204) may also include call history information from a call log or communication log of the trusted communication device 108. The call history information may include information describing the most recent communication at the trusted communication device, a predetermined number of most recent communications (e.g., last five, ten, twenty communications, etc.), the communications conducted over the last predetermined amount of time (e.g., hour, day, week, month, etc.), or the like. The call history information may also include information describing if there is any current ongoing call and, if so, whether or not a caller involved in the call is asking for sensitive information from the user 116.

Upon receiving the response message (S204), the transaction server 140 may invoke the location processing instructions 164 to process (S205) the location information from the response message (S204) and/or invoke the call history processing instructions 168 to process (S206) the call history information from the response message (S204). The authentication instructions 160 may then process (S207) outputs of the location processing instructions 164 and/or call history processing instructions 168. Specifically, the authentication instructions 160 may identify the transaction initiated by the transaction initiation message (S201a or S201b) as being valid (or possibly valid) if the location of the trusted communication device 108 as described by the location identifier in the response message (S204) matches or substantially matches the location of the device that originated the transaction initiation message (S201a or S201b). The authentication instructions 160 may also determine that the user 116 entered the time-sensitive code from the security message (S202) within the predetermined amount of time. If these conditions are met, then the authentication instructions 160 may notify the transaction processing instructions 156 to automatically allow the transaction to occur based on the transaction initiation message (S201a or S201b) being identified as valid. The authentication instructions 160 may also enable the alerting instructions 172 to transmit a transaction execution message (S208) to the user 116. The transaction execution message (S208) may be transmitted to the trusted communication device 108 and/or communication device 112 that initiated the transaction. In other words, the user 116 may be notified that the transaction has been automatically initiated, thereby giving the user 116 a chance to interrupt, pause, cancel, or verify details of the transaction one more time before the transaction server 140 finalizes the transaction.

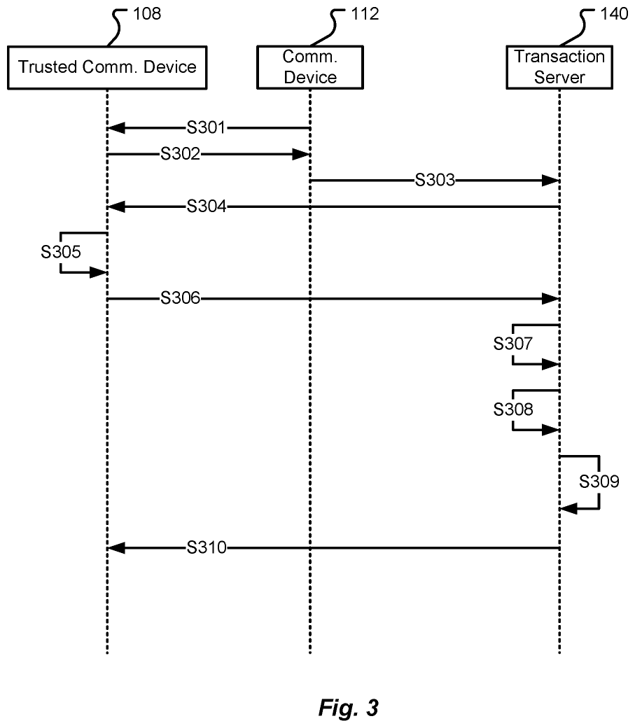

With reference now to FIG. 3, an illustrative message exchange for a fraudulent (or possibly fraudulent) transaction will be described in accordance with at least some embodiments of the present disclosure. While described as a possibly fraudulent transaction, it should be appreciated that some or all of the message exchanges described in connection with FIG. 3 may be determined to belong to a possibly valid or authentic transaction that is initiated by a legitimate user 116.

The message exchange may include an attacker 184 using a communication device 112 to initially communicate (S301) with the trusted communication device 108 or some other communication device 112 owned or operated by the legitimate user 116. The attacker 184 may eventually obtain (S302) secret or sensitive information from the user 116 during the communications. The secret or sensitive information may be obtained via voice communications, text communications, video communications, or the like.

Upon obtaining (S302) the secret or sensitive information from the user 116, the attacker 184 may initiate a transaction using some or all of the secret or sensitive information. Specifically, the attacker 184 may utilize a communication device 112 to transmit a transaction initiation message (S303) to the transaction server 140.

The transaction server 140 may respond to receiving the transaction initiation message (S303) by generating and transmitting a security message (S304) to the trusted communication device 108. The security message (S304) may be similar to the security message (S202) described in FIG. 2 because the transaction server 140 is currently unaware of whether the communication device 112 that transmitted the transaction initiation message (S303) is under control of a valid user 116 or an attacker 184.

The trusted communication device 108 may receive the security message (S304) and process the information contained in the security message (S304). In particular, the trusted communication device 108 may utilize its transaction instructions 132 and extract a time-sensitive code from the security message (S304). The time-sensitive code may be presented to the user 116 of the trusted communication device 108 such that the user 116 has to re-enter (S305) the time-sensitive code via a user interface of the trusted communication device 108 (or some other transacting device) within a predetermined amount of time of receiving the security message (S304). If the user 116 re-enters (S305) the time-sensitive code at the trusted communication device 108 (or some other transacting device) within the predetermined amount of time, then the trusted communication device 108 may transmit a response message (S306) back to the transaction server 140. In some embodiments, the response message (S306) need not wait for the time-sensitive code to be entered. Rather, the response message (S306) could be triggered in response to the trusted application on the trusted communication device 108 recognizing that a security message (S304) has been received and contains a time-sensitive code. This response message (S306) may be generated and formatted by the transaction instructions 132. In some embodiments, the response message (S306) may be generated to include location information and/or call history information for the trusted communication device 108. More specifically, the response message (S306) may include a location identifier that describes a location of the trusted communication device 108 at a time that the user 116 entered the time-sensitive code. The location identifier may be provided as GPS coordinates, network access point location, network access point identifier, network name, city name, street name, state name, country name, building information, etc. The response message (S306) may also include call history information from a call log or communication log of the trusted communication device 108. The call history information may include information describing the most recent communication at the trusted communication device, a predetermined number of most recent communications (e.g., last five, ten, twenty communications, etc.), the communications conducted over the last predetermined amount of time (e.g., hour, day, week, month, etc.), or the like.

Upon receiving the response message (S306), the transaction server 140 may invoke the location processing instructions 164 to process (S307) the location information from the response message (S306) and/or invoke the call history processing instructions 168 to process (S308) the call history information from the response message (S306). The authentication instructions 160 may then process (S309) outputs of the location processing instructions 164 and/or call history processing instructions 168. Specifically, the authentication instructions 160 may identify the transaction initiated by the transaction initiation message (S303) as being possibly fraudulent or invalid if the location of the trusted communication device 108 as described by the location identifier in the response message (S306) does not match or substantially match the location of the device that originated the transaction initiation message (S306). The authentication instructions 160 may also determine whether or not the user 116 entered the time-sensitive code from the security message (S304) within the predetermined amount of time. If any of these conditions are not met, then the transaction server 140 may identify the transaction as possibly fraudulent and take additional security measures. For instance, the authentication instructions 160 may invoke the alerting instructions 172 to transmit a fraudulent transaction attempt alert (S310) that is transmitted to the trusted communication device 108. Alternatively or additionally, the transaction server 140 may notify security personnel 180 of the possibly fraudulent transaction and provide details related to the attempted transaction.

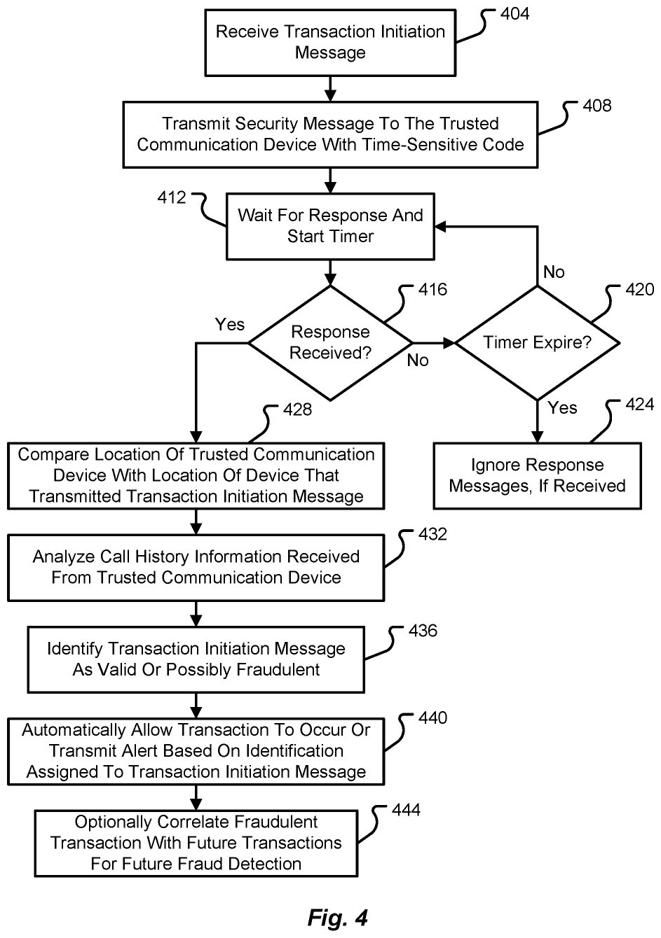

With reference now to FIG. 4, a method of authenticating a transaction in accordance with at least some embodiments of the present disclosure. The method begins when a transaction initiation message is received at the transaction server 140 (step 404). The transaction server 140 may respond to receiving the transaction initiation message by determining an address of a trusted communication device 108 and transmitting a security message to the trusted communication device (step 408). It should be appreciated that the address of the trusted communication device 108 may correspond to an IP address, MAC address, telephone number, or any other identifier used to direct communications to the trusted communication device 108 or a trusted application running on the trusted communication device 108.

In some embodiments, the security message may include a time-sensitive code (e.g., an OTP, a randomly generated alphanumeric string, or the like). The security message may require a user 116 of the trusted communication device 108 to enter the time-sensitive code or otherwise positively acknowledge receipt of the security message within a predetermined amount of time. Accordingly, the transaction server 140 may initiate a timer when the security message is transmitted or received at the trusted communication device 108. The timer value may begin counting down or up for a predetermined amount of time. During this period of time, the transaction server 140 may wait for a response from the trusted communication device 108 or some other transacting device (step 412). While waiting, the transaction server 140 may continue to determine whether or not a response to the security message has been received (step 416) before the timer expires (step 420). If no response is received before the timer expires, then the transaction server 140 may discontinue the transaction and ignore any response messages received after the timer expires (step 424).

If, on the other hand, a response to the security message is received at the transaction server before the expiration of the predetermined amount of time, then the transaction server 140 may continue by invoking the authentication instructions 156 to analyze the response message received from the trusted communication device 108. In some embodiments, the analysis may include comparing a location of the trusted communication device 108 with a location of the communication device 112 that transmitted the transaction initiation message (step 428). In some embodiment, the user 116 may utilize a web application from a first communication device 112 like a personal computer to initiate the transaction with the transaction server 140, but the personal computer may not support location identification of the first communication device 112. In this case, the transaction server 140 may use the IP address of the first communication device 112 from where the transaction has been initiated in order to determine the location information of the first communication device 112. The location information obtained from the trusted communication device 108 may then be compared with a location of the first communication device 112 as determined by the IP address of the first communication device 112 (e.g., a known or published physical location associated with the IP address).

The analysis may also include analyzing the contents of call history information as described in the response message with an address of the communication device 112 that transmitted the transaction initiation message (step 432). Analysis of the call history information may include analyzing at least one of: (i) a listing of numbers associated with incoming and outgoing calls at the trusted communication device 108 over the predetermined amount of time and (ii) call content obtained from a call conducted during the predetermined amount of time. In some embodiments, the transaction initiation message may be identified as possibly fraudulent in response to detecting at least one of the number of the first communication device in the call history information and the call content indicating a request for sensitive information.

Based on the analysis of the response message, the authentication instructions 160 may identify the transaction initiation message (and by proxy the transaction itself) as either valid or possibly fraudulent (step 436). Based on the results of step 440, the transaction server 140 may either automatically allow the transaction to occur or transmit one or more alert messages to the user 116 or a security personnel (step 440). If the transaction is identified as possibly fraudulent, then the method may include enforcing additional authentication processes. For instance, the user 116 may be challenged with a real-time query and response protocol that requires the user 116 of the trusted communication device 108 to provide a valid response to a query initiated by the transaction server 140. The query and response may be conducted using voice, video, text, or chat communications.

The method may also include enabling the transaction server 140 to optionally correlate information from a fraudulent transaction with future transactions (step 444). In particular, if a transaction initiation message is identified as fraudulent or possibly fraudulent, then information from that transaction initiation message (e.g., communication device 112 address, location, etc.) may be stored in memory 152 for referencing against future transaction initiation messages. If another transaction initiation message is received from the same or similar communication device 112 address, then the next transaction initiation message may be identified as possibly fraudulent without the need for transmitting a security message to a trusted communication device 108.

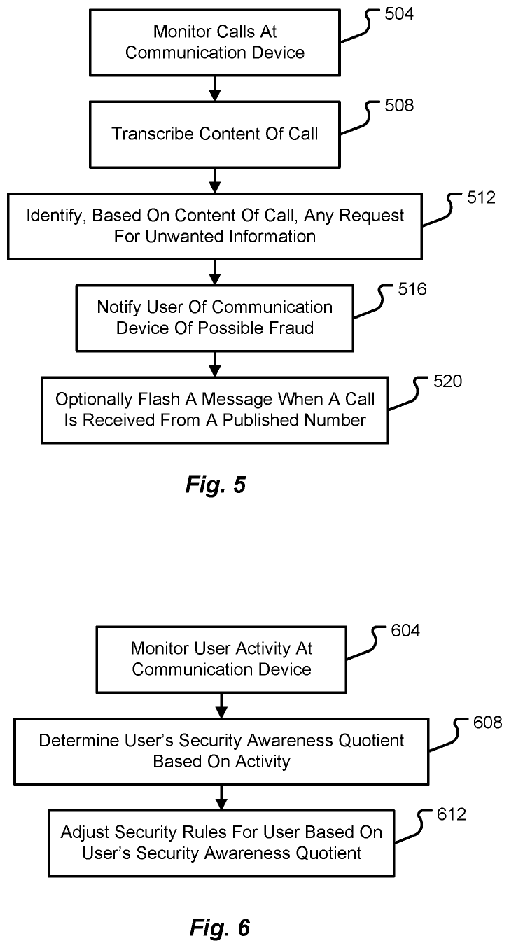

With reference now to FIGS. 5 and 6, additional security measures that may be performed by a trusted communication device 108 alone or in concert with a transaction server 140 will be described in accordance with at least some embodiments of the present disclosure. Referring initially to FIG. 5, one example of a method of operating a user's 116 communication device (e.g., device 108 or 112) to identify a possibly fraudulent transaction will be described in accordance with at least some embodiments of the present disclosure. The method begins by enabling the communication device to monitor communications between the user 116 of the device and other users at different communication devices (step 504). This analysis may include an analysis of voice calls, video calls, text messages, chats, web conferences, and/or social media interactions. Details of the communication that may be analyzed include, without limitation, addressing or phone numbers associated with the other communication device, time of day during which the communication occurs, day of week during which the communication occurs, and content (e.g., spoken or written content) of the messages exchanged during the communication.

If the analysis is being performed on voice or video calls (e.g., non-text-based communications), then the method may include transcribing content of the call (step 508). In some embodiments, the analysis of step 508 may only be initiated in response to a transaction being initiated, thereby avoiding unnecessary surveillance of the user 116. The method may then proceed by identifying, based on the content of the communication, whether any request has been made for unwanted information (step 512). Specifically, a trusted application on the communication device of the user 116 may analyze content of messages exchanged to see if the other user is requesting information that should not be shared by user 116 (e.g., financial information, identification information, private information, security information, passwords, PINs, etc.).

If the communication device of the user 116 detects that an inappropriate request has been made, then the communication device may notify the user 116 of possible fraud (step 516). The communication device of the user 116 may also be configured to flash a message or alert to the user 116 when a call is received from a number known to be associated with an attacker 184 or that appears to be a spoofed number (e.g., a number that is similar to, but not identical with an authentic number used by a service provider of the user 116) (step 520). The message provided to the user 116 may indicate that the incoming call is from a number that has a higher likelihood of being associated with a fraud attempt than other numbers.

Referring now to FIG. 6, a method of determining a user's 116 security awareness quotient and acting appropriately will be described in accordance with at least some embodiments of the present disclosure. The method begins by monitoring user 116 activity at a communication device (108 or 112) owned or operated by the user 116 (step 604). The activity monitored in this step may include applications used by the user 116 to conduct transactions, information exchanged during transactions, communication history of the user 116, messaging preferences of the user 116, responses to queries provided by the user 116, and the like.

Based on the observation of the user's 116 activities at the communication device, the user 116 may be assigned a security awareness quotient (e.g., a score that describes the user's 116 awareness of security concerns and best practices for responding to the same) (step 608). Depending upon the user's 116 security awareness quotient, the method may include a step of adjusting security rules for the user 116 (step 612). For instance, if the user 116 is determined to have a security awareness quotient that falls below a lower threshold predetermined value, then additional security measures (e.g., multi-factor authentication, transaction delays, etc.) may be put into place for the user 116. Alternatively, if the user 116 is determined to have a security awareness quotient that is above a higher threshold predetermined value, then more restrictive security measures may be bypassed for certain transactions.

While various methods and steps described therein may have been described with reference to operation of a trusted communication device 108, it should be appreciated that such steps may actually be performed by a trusted application of the communication device. In other words, descriptions of a trusted communication device 108 performing a particular step or method may correspond to a trusted application of a communication device performing the particular step or method.

Moreover, in some embodiments, the user 116 of trusted communication device 108 may be required to re-enter the secure code (e.g., time-sensitive code) in a transacting device rather than the trusted communication device 108. The transacting device may correspond to the communication device 112 or an application within the communication device 112 (e.g., some device which may be different from the trusted communication device 108). As an example, the user 116 may re-enter the secure code in a trusted application provided by the service provider. After entry of the code, the location identifier and/or call history will be sent to transaction server 140. Specifics of this timing and protocol may change depending on the legal requirements of the countries/geographies in which the system will be used. For example, in some countries it might be a legal requirement for the user 116 of trusted communication device 108 to re-enter the code at some other transacting device. Thus, while some of the figures and descriptions provided herein describe the need for a user 116 to re-enter a code as part of authentication, it should be appreciated that code entry may not necessarily be required as part of the disclosed embodiments.

The present disclosure, in various aspects, embodiments, and/or configurations, includes components, methods, processes, systems, and/or apparatus substantially as depicted and described herein, including various aspects, embodiments, configurations embodiments, sub-combinations, and/or subsets thereof. Those of skill in the art will understand how to make and use the disclosed aspects, embodiments, and/or configurations after understanding the present disclosure. The present disclosure, in various aspects, embodiments, and/or configurations, includes providing devices and processes in the absence of items not depicted and/or described herein or in various aspects, embodiments, and/or configurations hereof, including in the absence of such items as may have been used in previous devices or processes, e.g., for improving performance, achieving ease and\or reducing cost of implementation.

The foregoing discussion has been presented for purposes of illustration and description. The foregoing is not intended to limit the disclosure to the form or forms disclosed herein. In the foregoing Detailed Description for example, various features of the disclosure are grouped together in one or more aspects, embodiments, and/or configurations for the purpose of streamlining the disclosure. The features of the aspects, embodiments, and/or configurations of the disclosure may be combined in alternate aspects, embodiments, and/or configurations other than those discussed above. This method of disclosure is not to be interpreted as reflecting an intention that the claims require more features than are expressly recited in each claim. Rather, as the following claims reflect, inventive aspects lie in less than all features of a single foregoing disclosed aspect, embodiment, and/or configuration. Thus, the following claims are hereby incorporated into this Detailed Description, with each claim standing on its own as a separate preferred embodiment of the disclosure.

Moreover, though the description has included description of one or more aspects, embodiments, and/or configurations and certain variations and modifications, other variations, combinations, and modifications are within the scope of the disclosure, e.g., as may be within the skill and knowledge of those in the art, after understanding the present disclosure. It is intended to obtain rights which include alternative aspects, embodiments, and/or configurations to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. A method of authenticating a transaction at a transaction server, the method comprising:
receiving, at a processor and from a first communication device, a transaction initiation message;
determining, with the processor, an address of a trusted communication device to validate the transaction initiation message;
transmitting, with the processor, a security message to the trusted communication device, wherein the security message comprises a time-sensitive code;
receiving, with the processor and from the trusted communication device, a response message to the security message, wherein the response message comprises a location identifier that describes a location of the trusted communication device;
comparing, with the processor, the location of the trusted communication device as described by the location identifier in the response message with a location of the first communication device;
determining, with the processor, that a user entered the time-sensitive code within the predetermined amount of time;
identifying the transaction initiation message as either valid or possibly fraudulent in response to: (1) comparing the location of the trusted communication device as described by the location identifier in the response message with the location of the first communication device and (2) determining that the user entered the time-sensitive code within the predetermined amount of time; and
performing, with the processor, one of the following:
(iii) automatically allowing the transaction to occur based on the transaction initiation message being identified as valid; and
(iv) transmitting a fraudulent transaction alert based on the transaction initiation message being identified as possibly fraudulent.

2. The method of claim 1, wherein the response message further comprises call history information, the method further comprising:
comparing, with the processor, the call history information with a number of the first communication device; and
identifying the transaction initiation message as either valid or possibly fraudulent in response to comparing the call history information with the number of the first communication device.

3. The method of claim 2, wherein the call history information comprises at least one of: (i) a listing of numbers associated with incoming or outgoing calls at the trusted communication device over the predetermined amount of time and (ii) call content and wherein the transaction initiation message is identified as possibly fraudulent in response to detecting at least one of the number of the first communication device in the call history information and the call content indicating a request for sensitive information.

4. The method of claim 1, further comprising:
automatically initiating an additional authentication process in response to the transaction initiation message being identified as possibly fraudulent; and
delaying the transaction until the additional authentication process is completed.

5. The method of claim 4, wherein the additional authentication process comprises a real-time query and response protocol that requires the user of the trusted communication device to provide a valid response to a query initiated by the transaction server.

6. The method of claim 1, wherein the trusted communication device is different from the first communication device and wherein the time-sensitive code comprises a One-Time Password (OTP) that is entered by the user at a user interface of a transacting device so as to match the OTP received in the security message.

7. The method of claim 1, wherein transmitting the fraudulent transaction alert based on the transaction initiation message being identified as possibly fraudulent comprises:
transmitting the fraudulent transaction alert to the trusted communication device.

8. The method of claim 1, wherein transmitting the fraudulent transaction alert based on the transaction initiation message being identified as possibly fraudulent comprises:
transmitting the fraudulent transaction alert to security personnel at a communication device other than the trusted communication device.

9. The method of claim 1, further comprising:
monitoring behavior of the user at the trusted communication device;
determining, based on the monitored behavior of the user, a security awareness quotient for the user; and
increasing authentication requirements for transactions associated with the user based on the security awareness for the user quotient falling below a predetermined threshold value.

10. A communication system for authenticating a transaction, comprising:
a processor; and
computer memory storing data thereon that enables the processor to:
receive, from a first communication device, a transaction initiation message;
determine an address of a trusted communication device to validate the transaction initiation message;
transmit a security message to the trusted communication device, wherein the security message comprises a time-sensitive code;
receive, from the trusted communication device, a response message to the security message, wherein the response message comprises a location identifier that describes a location of the trusted communication device;
compare the location of the trusted communication device as described by the location identifier in the response message with a location of the first communication device;
determine whether or not a user entered the time-sensitive code within the predetermined amount of time;
identify the transaction initiation message as either valid or possibly fraudulent in response to: (1) comparing the location of the trusted communication device as described by the location identifier in the response message with the location of the first communication device and (2) determining whether or not the user entered the time-sensitive code within the predetermined amount of time; and
perform one of the following:
(i) automatically allow the transaction to occur based on the transaction initiation message being identified as valid; and
(ii) transmit a fraudulent transaction alert based on the transaction initiation message being identified as possibly fraudulent.

11. The communication system of claim 10, wherein the response message further comprises call history information and wherein the data stored on the computer memory further enables the processor to:
compare the call history information with a number of the first communication device; and
identify the transaction initiation message as either valid or possibly fraudulent in response to comparing the call history information with the number of the first communication device.

12. The communication system of claim 11, wherein the call history information comprises at least one of: (i) a listing of numbers associated with incoming and outgoing calls at the trusted communication device over the predetermined amount of time and (ii) call content and wherein the transaction initiation message is identified as possibly fraudulent in response to detecting at least one of the number of the first communication device in the call history information and the call content indicating a request for sensitive information.

13. The communication system of claim 10, wherein the data stored on the computer memory further enables the processor to:
automatically initiate an additional authentication process in response to the transaction initiation message being identified as possibly fraudulent; and
delay the transaction until the additional authentication process is completed.

14. The communication system of claim 10, wherein the trusted communication device is different from the first communication device, wherein the time-sensitive code comprises a One-Time Password (OTP) that is received by the user, and wherein receipt of the security message causes the trusted communication device to automatically generate the response message.

15. The communication system of claim 10, wherein the fraudulent transaction alert is transmitted to the trusted communication device and to another communication device of a security personnel.

16. A transaction server, comprising:
a processor; and
memory storing instructions there that are executable by the processor, wherein the instructions comprise:
instructions that process a transaction initiation message received from a first communication device;
instructions that transmit a security message to a trusted communication device in response to processing the transaction initiation message, wherein the security message comprises a time-sensitive code;
instructions that receive and process a response message to the security message, wherein the response message comprises a location identifier that describes a location of the trusted communication device;
instructions that compare the location of the trusted communication device as described by the location identifier in the response message with a location of the first communication device;
instructions that determine whether or not a user entered the time-sensitive code within the predetermined amount of time;
instructions that identify the transaction initiation message as possibly fraudulent in response to at least one of: (1) comparing the location of the trusted communication device as described by the location identifier in the response message with the location of the first communication device and (2) determining whether or not the user entered the time-sensitive code within the predetermined amount of time; and
instructions that transmit a fraudulent transaction alert based on the transaction initiation message being identified as possibly fraudulent.

17. The transaction server of claim 16, wherein the response message further comprises call history information that includes content of a call and wherein the instructions further comprise:
instructions that analyze the content of the call to determine if a request for sensitive information is included in the content of the call; and
instructions that transmit the fraudulent transaction alert based on the content of the call including the request for sensitive information.

18. The transaction server of claim 16, wherein the instructions further comprise:
instructions that automatically initiate an additional authentication process in response to the transaction initiation message being identified as possibly fraudulent; and
instructions that delay the transaction until the additional authentication process is completed, wherein the additional authentication process comprises a real-time query and response protocol that requires the user of the trusted communication device to provide a valid response to a query initiated by the transaction server.

19. The transaction server of claim 16, wherein the trusted communication device is different from the first communication device, wherein the time-sensitive code comprises a One-Time Password (OTP) that is received by the user, and wherein receipt of the security message causes the trusted communication device to generate the response message.

20. The transaction server of claim 16, wherein the fraudulent transaction alert is transmitted to the trusted communication device and to another communication device of a security personnel and wherein the instructions further comprise:
instructions that determine an active call is in progress between the trusted communication device and the first communication device;
instructions that determine the active call is in progress coincident with receiving the transaction initiation message;
instructions that determine, from call history information received from the trusted communication device, that a number of the first communication device is unknown to the trusted communication device; and
instructions that identify the transaction initiation message as possibly fraudulent in response to determining that the number of the first communication device is unknown to the trusted communication device.
